(19) United States
(12) Patent Application Publication
(10) Pub. No.: US 2014/0122414 A1
(43) Pub. Date: May 1, 2014

(54) METHOD AND SYSTEM FOR PROVIDING A PERSONALIZATION SOLUTION BASED ON A MULTI-DIMENSIONAL DATA

(71) Applicant: Xurmo Technologies Private Limited, Bangalore (IN)

(72) Inventor: SRIDHAR GOPALAKRISHNAN, BANGALORE (IN)

(73) Assignee: Xurmo Technologies Private Limited, Bangalore (IN)

(21) Appl. No.: 14/064,556

(22) Filed: Oct. 28, 2013

(30) Foreign Application Priority Data
Oct. 29, 2012 (IN) 4499/CHE/2012

(51) Int. Cl. G06F 17/30

(52) U.S. Cl. CPC G06F 17/30592
USPC 707/603

(57) ABSTRACT

The various embodiments herein provide a method for providing a personalization solution based on a multi-dimensional data. The method comprises of identifying a target event for personalization, profiling a plurality of entities associated with the target event, identifying a plurality of attributes adapted for predicting the target event, identifying one or more relevant attributes from the plurality of attributes, determining a personalization context associated with the target event, identifying at least one analysis algorithm for processing the identified target event and creating a predictive analytical model for building an optimal personalization solution. The target event is a personalization task which is formulated by analyzing an interaction between the plurality of entities. The plurality of entities are explanatory factors adapted for predicting an outcome of the target event.

### CROSS-REFERENCE TO RELATED APPLICATION

The present application claims priority of Indian provisional application serial number 4499/CHE/2012 filed on 29 Oct. 2012 and that application is incorporated in its entirety at least by reference.

### BACKGROUND

1. Technical Field

The present invention generally relates to data analysis and data mining of unstructured, structured and heterogeneous data. The present invention more particularly relates to a method and system for providing personalized and predictive solutions on data absorbed from heterogeneous sources on an intelligent platform.

2. Description of the Related Art

Information seekers are different in nature; they manifest heterogeneous information seeking behaviours, needs and expectations. Yet typically existing information services purport a “one size fits all model” whereby the same information is disseminated to a wide range of information seekers despite the individualistic nature of each user's needs, goals, interest, preferences, intellectual levels and information consumption capacity. Further, the information seekers who are intrinsically distinct are not only compelled to experience a generic outcome but are required to manually adjust and adapt the recommended information as per their requirements or preferences to achieve the desired results.

Personalization of data refers to customization of specific services, interests, and likes of a user. The personalization facilitates services, offers to the user, based on the user's characteristics and preferences. Personalization helps in building a healthy and long lasting relationship with consumers.

Generally, data is present in many forms like textual, numeric, time based, cross sectional etc. In any organization, the data might also be present about various aspects of the organization, the Subject, the Decider, and the environment in general. Identifying the relevant data for the prediction problem and algorithm is therefore not trivial. These issues add significant complexity in formulating the prediction problem and then selecting a satisfactory predictive model which can be used to enable the business process.

The typical approach used by companies to solve such problems is to employ a specialist Data Scientist (DS) who understands the advanced analytics techniques. The DS often takes inputs from a domain expert and a Business Analyst (BA) in formulating the predictive analytics model. Typically the DS understands the existing sources of data and tries to identify predicting factors to be used in one or more predictive models. The DS also tests multiple algorithms in an attempt to find a good predictive model. The effectiveness of the predictive model is highly dependent on the quality and quantity of predictive factors that have been identified. Irrelevant predictive factors lead to poor or erroneous predictions. This approach takes time, effort and specialized knowledge. Further this approach looks at only obvious predictive factors from the existing sources of data.

However, the size of data and the complexity of the problem being addressed make the task of building a solution on an intelligent platform reasonably complex. Right from identifying the personalization context, understanding the quality of data, identifying the most useful section of data for personalization to build the solution with the right algorithm, each of the tasks call for specialized skills.

Therefore, there is a need for a method and system that takes into account the individuality of information seekers and in turn aims to personalize the information seeking experience and outcome for users. There is also a need for a method and system for providing personalization solutions based on multi-structured data. Further, there is a need for a method and system for formulating a personalized prediction problem and corresponding predictive model for enabling an effective business process.

The abovementioned shortcomings, disadvantages and problems are addressed herein and which will be understood by reading and studying the following specification.

### SUMMARY

The primary object of the embodiments herein is to provide a system and method for analyzing, personalizing and formulating a predictive analytics model for a target event.

Another object of the embodiments herein is to provide a method and system for creating a personalized prediction solution for a user based on multi-structured data.

Yet another object of the embodiments herein is to provide a method and system for identifying a relevant algorithm from multitude of algorithms for analyzing the relevant data.

Yet another object of the embodiments herein is to provide a method and system for identifying a framework to simplify and speed up the predictive analytics problem formulation process.

Yet another object of the embodiment herein is to provide a standardized framework along with enabling tools and templates for creating analytics models to be used to solve personalized predictive business problems.

These and other objects and advantages of the present embodiments will become readily apparent from the following detailed description taken in conjunction with the accompanying drawings.

The various embodiments herein provide a method for providing a personalization solution based on a multi-dimensional data. The method comprises the steps of identifying a target event for personalization, profiling a plurality of entities associated with the target event, identifying a plurality of attributes adapted for predicting the target event, identifying one or more relevant attributes from the plurality of attributes, determining a personalization context associated with the target event, identifying at least one analysis algorithm for processing the identified target event, and creating a predictive analytical model for building an optimal personalization solution.

According to an embodiment herein, the target event is a personalization task which is formulated by analyzing an interaction between the plurality of entities. The plurality of entities are explanatory factors adapted for predicting an outcome of the target event.

According to an embodiment herein, the plurality of entities comprises a decider entity, adapted to perform a plurality of functions according to one or more recommendations provided by a personalization application, and a subject entity, on which a decision of the personalization application is applied. The subject entity and the decider entity comprise at least one of an entity, an employee or a consumer.

According to an embodiment herein, the plurality of attributes comprises an intrinsic attribute, a behavioral attribute and an environmental attribute.

According to an embodiment herein, profiling the plurality of entities associated with the target event comprises relating the plurality of entities based on the plurality of attributes defined along three dimensions of data. The three dimensions of data comprise an intrinsic data, a behavioral data and environmental data.

According to an embodiment herein, identifying the plurality of attributes comprises the steps of identifying one or more data sources for providing the attributes, connecting an analysis platform to the one or more identified data sources, loading one or more attributes from the data sources to the analysis platform, processing the one or more attributes, recognizing one or more relevant attributes by computing a relevance metric based on a semantic distance and a temporal distance between at least one attribute and the target event. The one or more attributes are predictive factors associated with the target event.

According to an embodiment herein, the personalization context is determined by classifying the plurality of attributes into a preset number of segments, wherein each segment corresponds to a specific family of algorithms.

According to an embodiment herein, identifying at least one analysis algorithm comprises, mapping the personalization context of the target event with a corresponding algorithm family.

Embodiments further disclose a system combined with one or more processor implemented instructions for providing a personalization solution based on a multi-dimensional data is described. The system comprising an analyzing module adapted for identifying a target problem to be personalized, a profiling module adapted for profiling one or more entities associated with the target event, a predictive analytical module adapted for building an optimal personalization solution for the target event and a personalization module. The personalization module is adapted for identifying a plurality of attributes adapted for predicting the target event, identifying one or more relevant attributes from the plurality of attributes, determining a personalization context associated with the target event, and identifying at least one analysis algorithm for processing the identified target event.

According to an embodiment herein, the plurality of entities comprises a subject entity on which a prediction is to be made and a decider entity which selects a desired subject entity for predicting a personalization solution.

According to an embodiment herein, the target event comprises characteristics of the decider entity and the subject entity.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a flow diagram illustrating a process for creating a personalized predictive analytical model, according to an embodiment of the present disclosure.

FIG. 2 is a block diagram illustrating a system for creating a personalized predictive analytical model, according to an embodiment of the present disclosure.

FIG. 3 is a block diagram illustrating the functional blocks employed for identifying a personalization problem and formulating a target event, according to an example embodiment of the present invention.

FIG. 4 is an attribute matrix illustrating the profiling of the subject and decider, according to an embodiment of the present disclosure.

FIG. 5 illustrates a three dimensional data mechanism for identifying a personalization context of the target event, according to an embodiment of the present disclosure.

FIG. 6 illustrates a table defining different algorithm family corresponding to a specific personalization context, according to an embodiment of the present disclosure.

FIG. 7A illustrates a plurality of attributes across the three dimensional data structure for profiling the subject and decider entities, according to an exemplary embodiment of the present disclosure.

FIG. 7B illustrates an identified set of data sources fbr acquiring information for different attributes relating to subject and decider entities, according to an exemplary embodiment of the present disclosure.

FIG. 7C illustrates a graphical method for identifying relevant attributes from plurality of attributes, according to an exemplary embodiment of the present disclosure.

FIG. 7D illustrates a block diagram of identified relevant attributes to the target event based on the graphical method of FIG. 7C according to an exemplary embodiment of the present disclosure.

FIG. 7E illustrates a table for identifying a personalization context based on the identified relevant attributes, according to an exemplary embodiment of the present disclosure.

FIG. 7F illustrates a table defining different algorithm family corresponding to a specific problem type, according to an exemplary embodiment of the present disclosure.

FIG. 7G illustrates a training data set table to learn the predictive model for existing customers, according to an exemplary embodiment of the present disclosure.

FIG. 8 illustrates a schematic representation of optimized personalization solution recommendation, according to an embodiment of the present disclosure.

Although the specific features of the present embodiments are shown in some drawings and not in others. This is done for convenience only as each feature may be combined with any or all of the other features in accordance with the present embodiments.

### DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for providing a personalization solution based on a multi-dimensional data. The method comprises the steps of identifying a target event for personalization, profiling one or more entities associated with the target event, identifying a plurality of attributes adapted for predicting the target event, identifying one or more relevant attributes from the plurality of attributes, determining a personalization context associated with the target event, identifying at least one analysis algorithm for processing the identified target event, and creating a predictive analytical model for building an optimal personalization solution.

The target event is a personalization task which is formulated by analyzing an interaction between the one or more entities. The one or more entities are explanatory factors for predicting an outcome of the target event.

The one or more entities comprises a decider entity, adapted to perform a plurality of functions according to one or more recommendations provided by a personalization application, and a subject entity, on which a decision of the personalization application is applied. The subject entity and the decider entity comprise at least one of an entity, an employee or a consumer. The plurality of attributes comprises an intrinsic attribute, a behavioral attribute and an environmental attribute.

The method of profiling the one or more entities associated with the target event comprises, relating the one or more entities based on the plurality of attributes defined along three dimensions of data. The three dimensions of data comprise an intrinsic data, a behavioral data and environmental data.

The method identifying the plurality of attributes comprises the steps of identifying one or more data sources for providing the attributes, connecting an analysis platform to the one or more identified data sources, loading one or more attributes from the data sources to the analysis platform, processing the one or more attributes, recognizing one or more relevant attributes by computing a relevance metric based on a semantic distance and a temporal distance between at least one attribute and the target event. The one or more attributes are predictive factors associated with the target event.

The personalization context is determined by classifying the plurality of attributes into a preset number of segments, wherein each segment corresponds to a specific family of algorithms

Identifying at least one analysis algorithm comprises mapping the personalization context of the target event with a corresponding algorithm family.

According to an embodiment herein, a system combined with one or more processor implemented instructions for providing a personalization solution based on a multi-dimensional data is described. The system comprising an analyzing module adapted for identifying a target problem to be personalized, a profiling module adapted for profiling one or more entities associated with the target event, a predictive analytical module adapted for building an optimal personalization solution for the target event and a personalization module. The personalization module is adapted for identifying a plurality of attributes adapted for predicting the target event, identifying one or more relevant attributes from the plurality of attributes, determining a personalization context associated with the target event, and identifying at least one analysis algorithm for processing the identified target event.

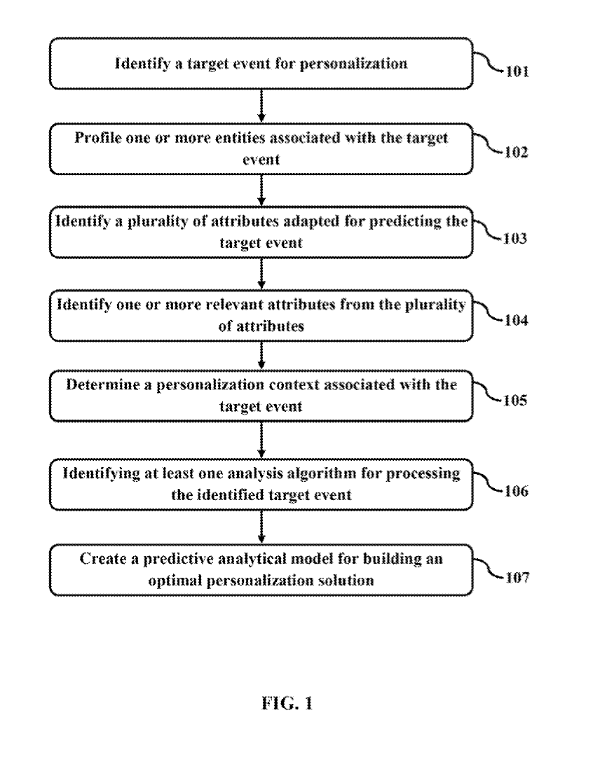

FIG. 1 is a flow diagram illustrating a process for creating a personalized predictive analytical model, according to an embodiment of the present disclosure. The process comprises of identifying a target event for personalization (101). The target event is formulated as an interaction between a decider entity and a subject entity. The target event is then modeled as a personalization problem. The identification of target event is followed by profiling a plurality of entities associated with the target event (102). The profiling of the plurality of entities is performed based on a plurality of attributes along the three dimensions comprising an environmental data, an intrinsic data and a behavioral data. The profiling is accomplished by adopting a profiling module or a sub-framework. The profiling module helps a DS and a BA in identifying a variety of attributes without initially taking into consideration the sources of data. The relevant attributes are also called as predictive factors. The profiling process is followed by identifying a plurality of attributes adapted for predicting an outcome of the target event (103). The pluralities of attributes are identified by adopting a feature selection module also known as a sub-framework based on a two dimensional model of semantic and temporal distance metrics. The feature selection module helps the data scientists to narrow down and identify the most relevant attributes quickly thus reducing the exploratory analysis that is usually performed at this stage (104).

Once the relevant attributes to the target event are identified, then a personalization context associated with the target event is determined (105). The determination of the personalization context refers to determining a problem type of the target event. Based on the data coverage and characteristics, a problem type module/sub-framework is adopted for classifying the target event into a standard problem type or a personalization context. The identification of the personalization context helps in reducing the time taken by the DS to identify the most appropriate predictive analytics model for solving the target event. Based on the identified personalization context, a corresponding algorithm family is selected for solving the target event. An algorithm family choice module/sub-framework is adopted for mapping the personalization context into an algorithm family. From the mapped algorithm family, at least one analysis algorithm is identified for processing or solving the identified target event (106). With the help of the at least one analysis algorithm, a predictive model is created for building an optimal personalization solution (107). The DS employs the predictive model with the selected algorithm from the recommended algorithm family and observes the output. The predictive model is also further refined by iterating the entire process.

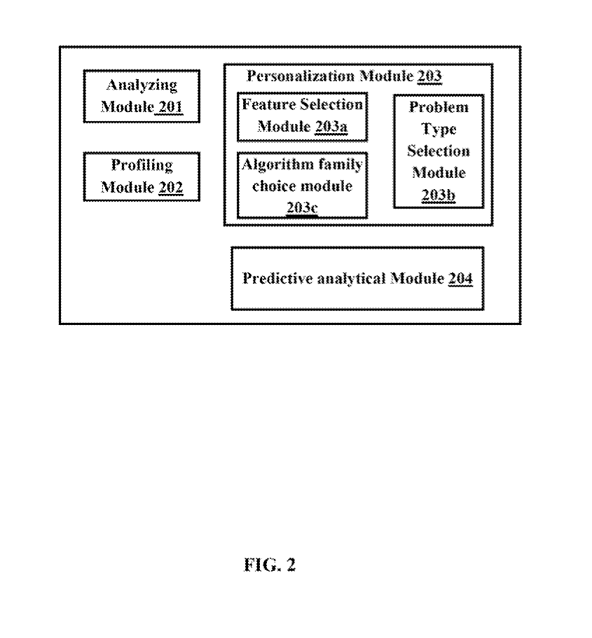

FIG. 2 is a block diagram illustrating a system for creating a personalized predictive analytical model, according to an embodiment of the present disclosure. The system comprises an analyzing module 201, a profiling module 202, a personalization module 203 and a predictive analytical module 204. The entire system modules or sub-framework are executed over a standardized framework along with providing enabling tools and templates, to create analytics models to be used to solve personalized predictive business problems. The analytics model is then used to create predictions to be acted upon in specific business contexts. The analyzing module 201 is adapted for identifying a target event to be personalized. Specifically, those target events requiring a prediction of the behavior of a person or system and then taking a decision and concomitant actions. The profiling module/sub-framework 202 assists a DS and a BA in providing a plurality of attributes/predictive factors without initially taking into consideration the sources of data. The profiling is performed along a three dimensional data comprising an intrinsic data, a behavioral data and an environmental data. The personalization module 203 comprises a feature selection module 203a, a problem type selecting module 203b and an algorithm family choice module 203c. The feature selecting module selects one or more relevant attributes or predictive factors from the three dimensional data for solving the target event. The problem type selecting module selects a personalization context of the target event. The algorithm family choice module assists in mapping the identified personalization context to an appropriate algorithm family for further processing. The predictive analytical 204 module adapted for building an optimal personalization solution for the target event by creating and refining a predictive model.

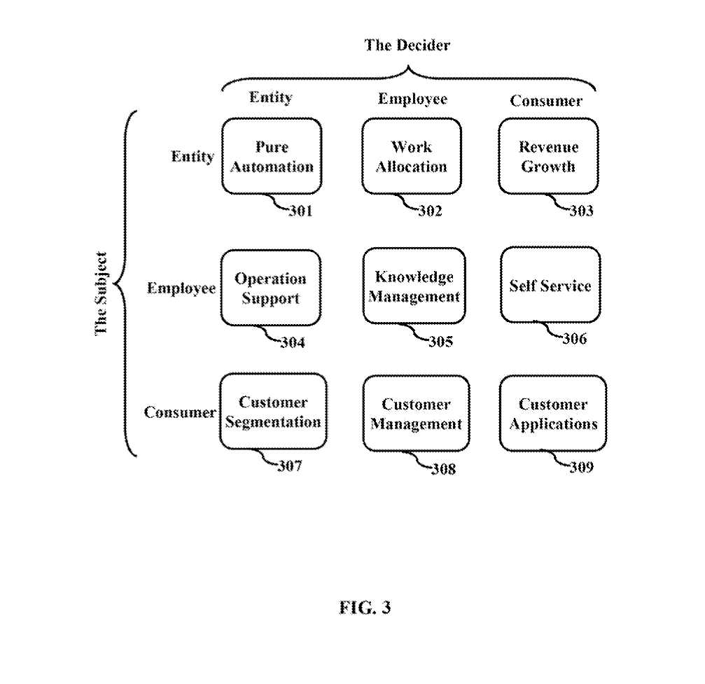

FIG. 3 is a block diagram illustrating the functional blocks employed for identifying a personalization problem and formulating a target event, according to an example embodiment of the present invention. A personalization problem is to be first identified for providing a result. The personalization problem is then formulated to a target event comprising one or more entities. The target event is specifically created by a decider entity on a subject entity. The subject entity refers to a person or entity on which the decision of the personalization application is to be applied. The subject entity comprises entities, employees and consumers. Similarly, the decider entity comprises entities, employees and consumers. The entity is a machine or object but not an employee or customer. The employee refers to an employee of a company. The consumer refers to a customer of a company, an individual or a company itself. The personalization tailors a digital experience for a segment based on past behavior and a current context. The personalization performs predictive analysis and matchmaking on a plurality of personalization segments/tasks. The plurality of personalization task between subjects and decision maker comprises entity-entity, entity-employee, entity-consumer, employee-entity, employee-employee, employee consumer, consumer-entity, consumer-employee and consumer-consumer. The entity-entity personalization task comprises a pure automation process 301. The pure automation 301 process in turn provides for log analysis, equipment failure prediction, stock prediction, demand prediction, automated steering and the like. The entity-employee personalization task comprises a work allocation phase 302 which includes equipment maintenance and planning. The entity-consumer personalization task comprises a revenue growth phase 303. The revenue growth phase 303 comprises a stock recommender, a product recommender, a news recommender etc. The employee-entity personalization task comprises an operations support phase 304 comprising an attrition prediction, a project assigner, a career planner, etc. The employee-employee personalization task comprises a knowledge management block 305 which includes enterprise search. The employee consumer personalization task comprises a self service block 306 which in turn contains an investment advisor and recommender. The consumer-entity personalization task comprises customer segmentation block 307. The customer segmentation block 307 facilitates churn prediction, new hire fitment, health insurance-risk profiling, insurance claims, processing fraud detection, etc. The consumer-employee personalization task comprises a customer management block 308. The customer management block 308 provides prospect allocation, service operations etc. The consumer-consumer personalization task comprises a personal application block 309 which includes a calendar scheduler, personal physician, and the like.

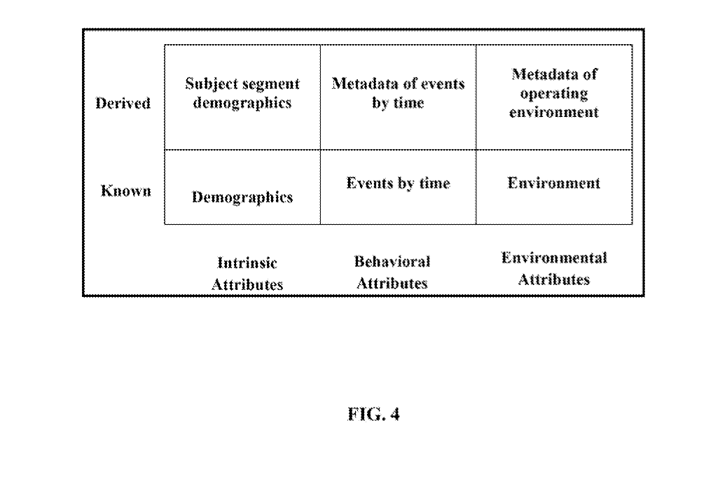

FIG. 4 is an attribute matrix illustrating the profiling of the subject and decider, according to an embodiment of the present disclosure. For performing a profiling process, understanding of what kind of data is available and what kind of data is required is very important. In this context, the information is categorized as intrinsic data, behavioral data and environmental data. The attributes along the intrinsic data are called as intrinsic attributes that do not change with time, the attributes along the behavioral data are called as behavioral attributes which changes with time and the attributes along the environmental data are called environmental attributes which are external factors that have some impact on the subject entity. The attributes herein is basically categorized into known attributes and derived attributes. For instance, the known intrinsic attribute comprises demographics such as gender; age etc whereas the derived intrinsic attribute comprises subject segment demographics such as a pre-defined segmentation category. Similarly the known behavioral attributes include events by time, for example purchase history, and the derived behavioral attributes include metadata of events by time such as sentiment. Likewise, the known environmental attributes include details of operating environment such as population, industry, growth rate, etc and the derived environmental attributes comprises metadata of operating environment for example market segment.

With respect to FIG. 4, in an intrinsic attribute an entity is associated with multiple attributes. A similar entity to the subject entity is possibly defined on the basis of some similarity metric. Any similar entity may have a set of attributes which should be a subset of the Subject Entity's attribute set. The data is of following forms but not limited to numeric, text, and alpha-numeric. The behavioral attributes are typically events happening in time and defines data based on the time (date and/or time) the data was captured or the time which is attached to every data point. The behavioral attribute is also termed as temporal data/historical data where the time information is not captured is not considered temporal data. The temporal data is available at regular time intervals or does not have a repeated time structure. The former is a regular temporal data and the latter is irregular temporal data. The environmental attributes provides explanatory entities which are not considered similar to the subject entity but entities whose attributes explain or predict a target entity's behavior. The three dimensional data, capture the various facets of the target event or the personalization problem.

According to an embodiment herein, in the profiling process, all possible attributes for the subject entity, decider entity and any other entities, which serve as explanatory factors for predicting the target event are identified. The BA's domain expertise comes into play here in identifying the attributes. The profiling process is performed without taking into consideration available data sources so as to not restrict the possibilities. Then, the data sources which provide details for the attributes are identified, whether directly or indirectly by deriving from other attributes. Some attributes are not present in any accessible data source. These attributes are then removed from a candidate list for further analysis. The candidate list comprises list of attributes for further processing.

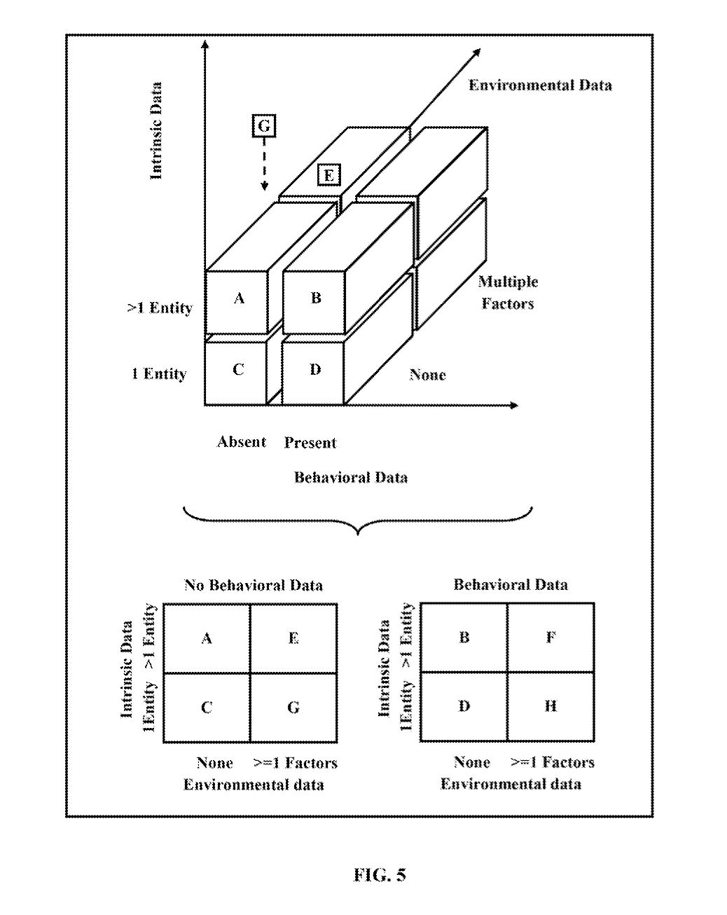

FIG. 5 illustrates a three dimensional data mechanism for identifying a personalization context of the target event, according to an embodiment of the present disclosure. Based on the target event, the three dimensions comprising an intrinsic data, a behavioral data and an environmental data, forms the basis for identifying the personalization context or the problem type. A set of use-case segment by type and quality of data are provided as shown in FIG. 5. The set of use-case segment are represented by capital English letters comprising A, B, C, D, E, F, G and H. The use-case segment A refers to intrinsic data with greater than one entity, no environmental data and no behavioral data. The use-case segment B refers to intrinsic data greater than one entity, absence of environmental data and presence of behavioral data. The use-case segment C refers to intrinsic data with one entity, no environmental data and no behavioral data. The use-case segment D refers to intrinsic data with one entity, absence of environmental data and presence of behavioral data. The use-case segment E refers to intrinsic data greater than one entity, environmental data having greater than or equal to one factor and no behavioral data. The use-case segment F refers to intrinsic data with more than one entity, environmental data having greater than or equal to one factor and presence of behavioral data. The use-case segment G refers to intrinsic data with one entity, environmental data having greater than or equal to one factor and none behavioral data. The use-case segment H refers to intrinsic data with one entity, an environmental data having greater than or equal to one factor and presence of a behavioral data.

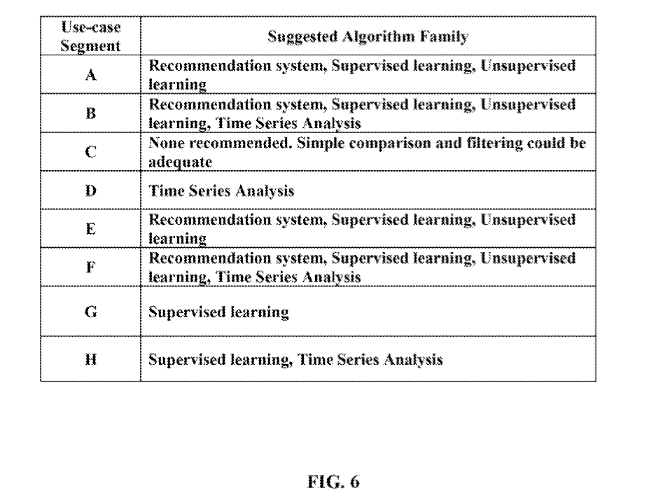

FIG. 6 illustrates a table defining different algorithm family corresponding to a specific personalization context, according to an embodiment of the present disclosure. The algorithm choice framework maps the personalization context to relevant analysis algorithm families. Each algorithm family comprises multiple analysis algorithms. The table comprises two columns comprising a user case segment and a suggested algorithm family. The use case segment comprises eight cases labeled from A to H. For each use case segment a suggested algorithm family is provided. For the target event whose use case segment is identified to be A, the suggested algorithm family comprises recommendation system, supervised learning and unsupervised learning. For the target event with use case segment B, the suggested algorithm family comprises recommendation system, supervised learning, unsupervised learning and time series analysis. For the target event with use case segment C, the suggested algorithm family comprises non recommended, simple comparison and filtering is adequate. For the target event with use case segment D, the suggested algorithm family comprises time series analysis. For the target event with use case segment E, the suggested algorithm family comprises recommendation system, supervised learning and unsupervised learning. For the target event with use case segment F, the suggested algorithm family comprises recommendation system, supervised learning, unsupervised learning and time series analysis. For the target event with use case segment G, the suggested algorithm family comprises supervised learning. For the target event with use case segment H, the suggested algorithm family comprises supervised learning and time series analysis. The suggested algorithm family for each use case segment is provided as an example and must not be taken in limiting sense.

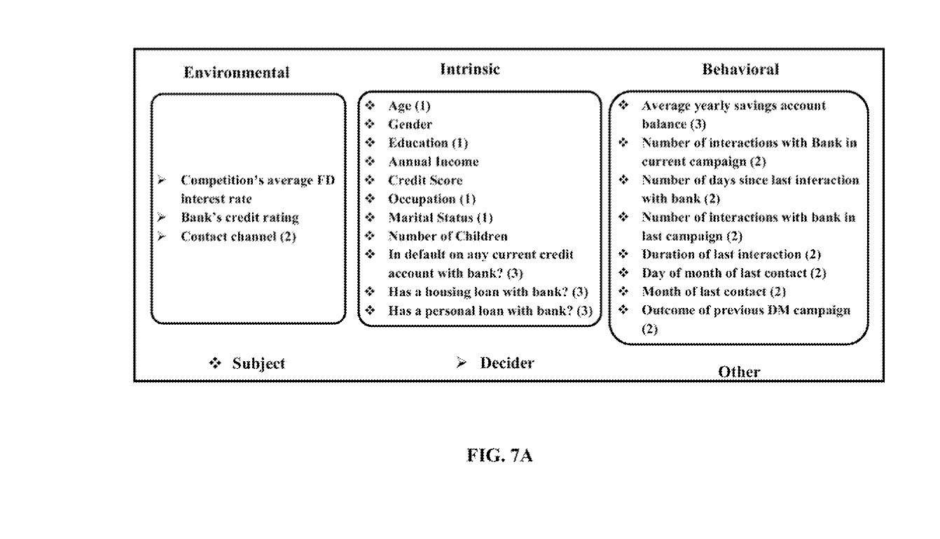

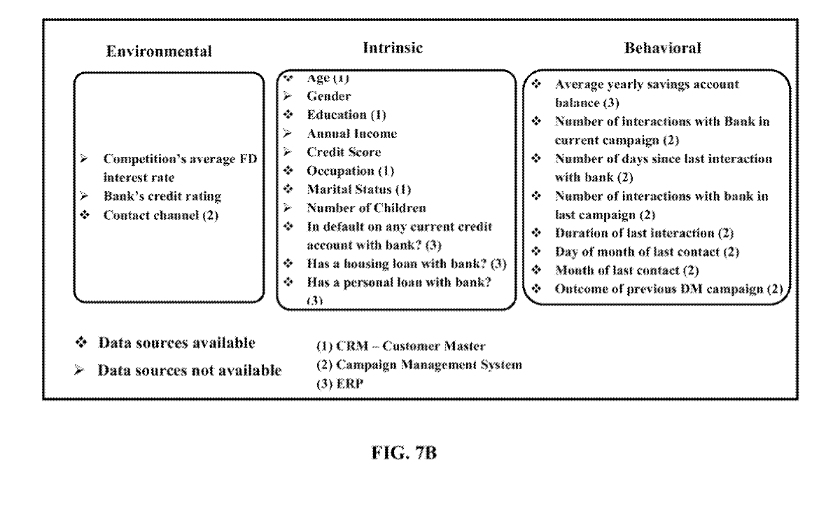

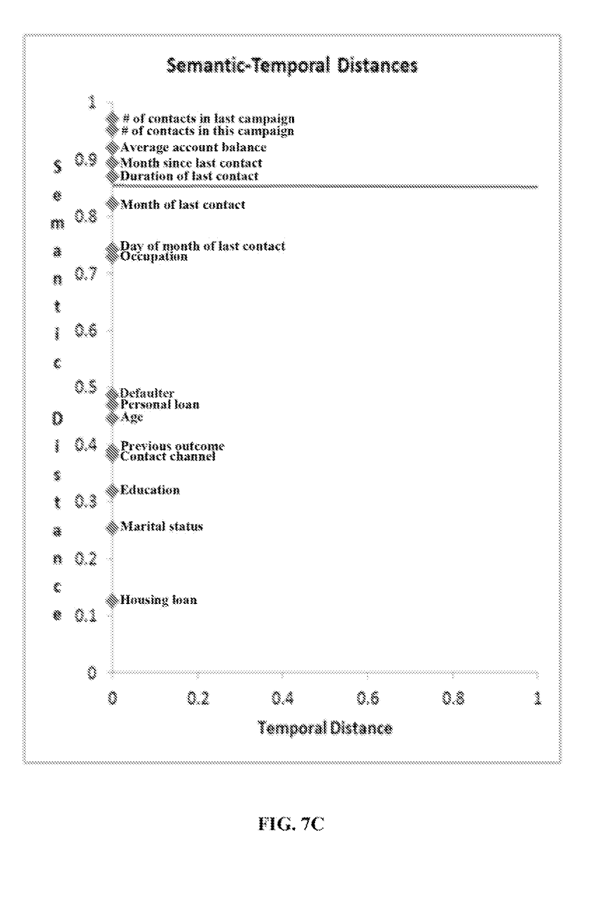

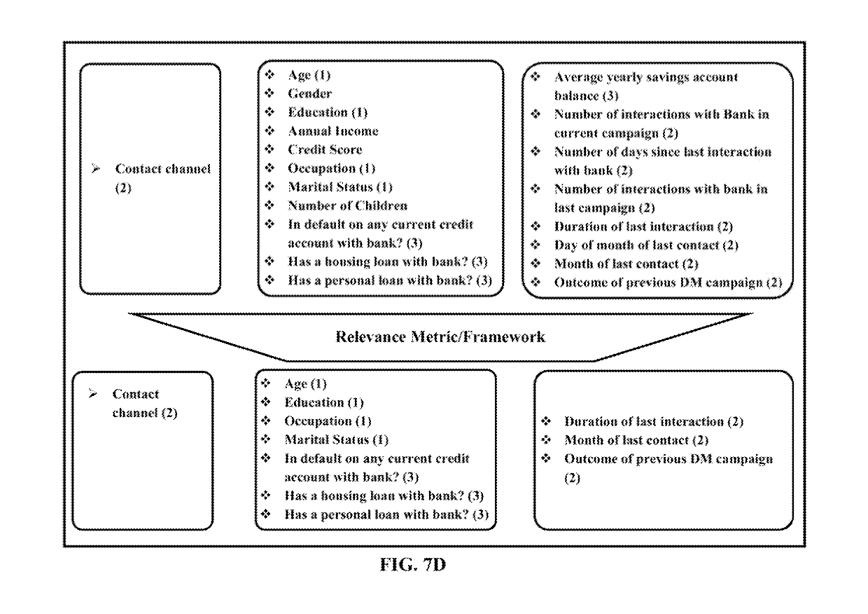

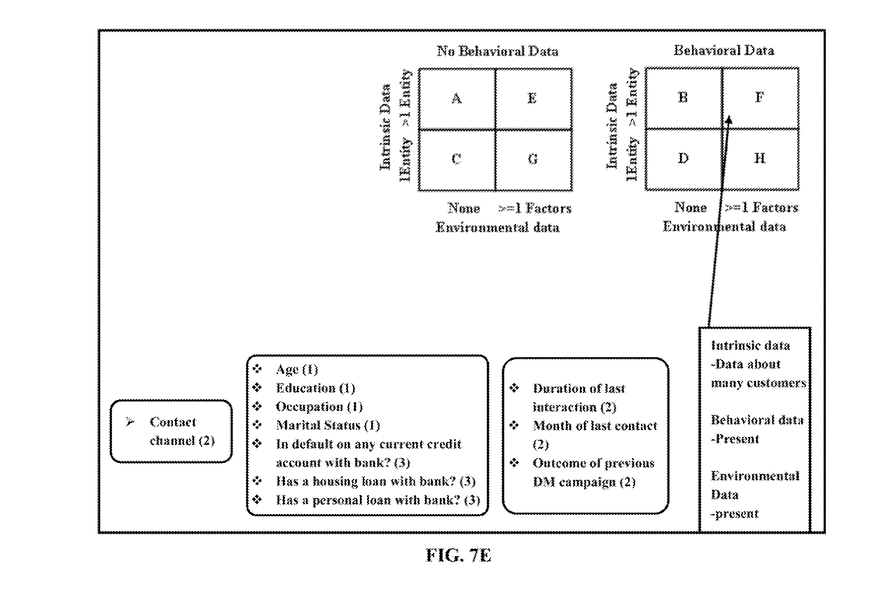

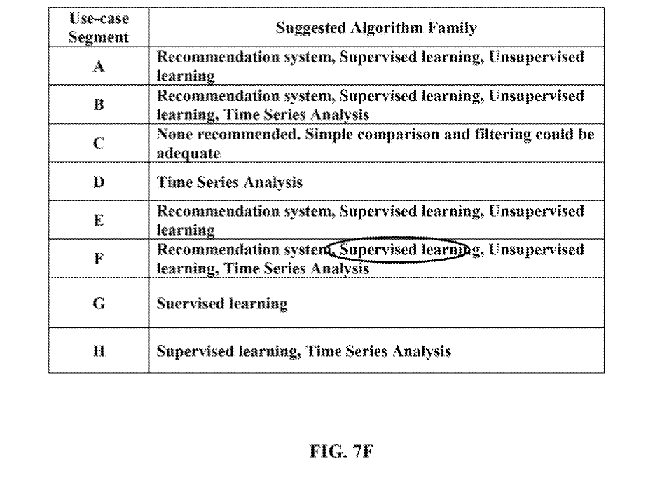

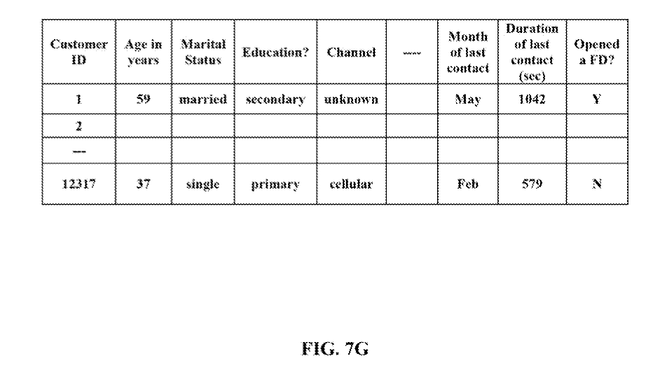

FIG. 7A-7G is an example illustration of the embodiments herein, where describes a use case scenario of a bank Direct Marketing (DM) campaign where prediction of customer response to a direct marketing campaign is required. The context of the case herein is as follows. A bank would like to reuse an existing direct marketing (DM) campaign on its existing savings account customers to induce them to open a fixed deposit (FD) account at a branch. The DM campaign is conducted via different channels such as landline phone, mobile phone and home visits. Multiple contacts may be made with a target customer. The Bank's Marketing Manager would like to be able to predict, for any target customer, whether the DM campaign will be successful or not. This prediction could be performed at any stage of the DM campaign.

In view of the foregoing, FIG. 7A illustrates a plurality of attributes across the three dimensional data structure for profiling the subject and decider entities, according to an exemplary embodiment of the present disclosure. With respect to the FIG. 7A, the first step comprises identifying the personalization problem and formulating the target event. Thus, a subject entity is a bank customer for whom the prediction is to be made. The decider entity is none, as for a marketing campaign, the characteristics of a marketing manager are assumed not to affect the outcome. The target event is opening of a FD account following the DM campaign. Once the target event is formulated, the next step is to profile the subject and the decider entities. The profiling is performed along a three dimensional data structure comprising an intrinsic data, a behavioral data and an environmental data. Based on the case, the intrinsic data comprises attributes such as age, gender, education, annual income, credit score, occupation, marital status, number of children, in default on any current credit account with bank?, has a housing loan with bank?, has a personal loan with bank?, etc. The behavioral data comprises attributes such as average yearly savings account balance, number of interactions with bank in current campaign, number of days since last interaction with bank, number of interaction with bank in last campaign, duration of last interaction, day of month of last contact, month of last contact, outcome of previous DM campaign, etc. Similarly, the environmental data comprises attributes such as competition's average FD interest rate, bank's credit rating, contact channel, etc.

FIG. 7B illustrates an identified set of data sources for acquiring information for different attributes relating to subject and decider entities, according to an exemplary embodiment of the present disclosure. With respect to FIGS. 7A and 7B, the data required for plurality of attributes in intrinsic, behavioral and environmental data structure are extracted by identifying the relevant data sources. The attributes for which data sources are identified are made bold and a number is assigned within parenthesis. The number in the parenthesis signifies the data source under which the information relating to the attributes is available. The attributes for which the data sources are not available are made light in color. This kind of the representation is used only for illustration and must not be taken in limiting sense.

FIG. 7C illustrates a graphical method for identifying relevant attributes from plurality of attributes, according to an exemplary embodiment of the present disclosure. Before identifying relevant attributes from plurality of attributes, the DS connects an analysis platform to the previously identified data sources. The DS then loads data into the analysis platform and performs any data cleaning and preparation activities as required and creates one or more derived attributes as required. The identification of attributes most relevant to explaining the target event is accomplished by the analysis platform or manually by an analyst. The embodiments herein provide a method for identifying the relevant attributes by adopting a graphical method. The graphical method comprises a relevance metric based on semantic and temporal distances between any attribute and the target event. The relevance metric is used to identify the most appropriate attributes. The semantic distance is a type of similarity metric while the temporal distance is a type of correlation metric which captures co-occurrence in time. The analysis platform identifies those attributes which fall within a specified threshold based on the semantic and temporal distance between the target event and the attribute. This step is optional if the attribute set is deemed adequate. The semantic distance and temporal distance metrics range from 0 to 1. A higher value indicates a lower relevance of the attribute to the target event. The analyst is also allowed to use the distance information in a stepwise manner to identify attributes entering or exiting a model. The thresholds are specified based on an understanding of the data, the analysis algorithm model and the domain. The FIG. 7C shows a graph plotted on two axes namely between semantic distance in vertical axis and temporal distance in horizontal axis. For the bank's DM target event there is no temporal or time information in the data and hence all attributes have a temporal distance of 0. Further, a threshold of 0.85 is considered for identifying the most appropriate explanatory attributes from the candidate set.

FIG. 7D illustrates a block diagram of identified relevant attributes to the target event based on the graphical method of FIG. 7C according to an exemplary embodiment of the present disclosure. The three dimensional data structure comprises an intrinsic data, a behavioral data and an environmental data with a plurality of attributes refined by the graphical method as adopted in FIG. 7C. The refined and relevant attributes under each of the three dimensional data structure are displayed under the relevance metric. In this example, all the attributes under intrinsic and environmental attributes are considered to be relevant, but only three attributes from behavioral attribute are considered to be relevant.

FIG. 7E illustrates a table for identifying a personalization context based on the identified relevant attributes, according to an exemplary embodiment of the present disclosure. Based on the type of relevant attributes, a personalization context or the problem type for the target event is identified. For identifying a personalization context, the identified relevant attributes are analyzed for the required data in the three dimensional data comprising intrinsic, behavioral and environmental data. Considering an example where intrinsic data comprises attributes about many customers. If respective behavioral attributes and environmental attributes are present then the target event is mapped with a use case segment F. The use case segment F comprises family of algorithm specifically for processing the mapped target event.

FIG. 7F illustrates a table defining different algorithm family corresponding to a specific problem type, according to an exemplary embodiment of the present disclosure. With respect to FIG. 7E, a use case segment F is mapped with the target event. Now with respect to FIG. 7F, multiple algorithm families are possible with the identified problem type or the personalization context. The use case segment F corresponds to a family of algorithm comprising but not limited to a recommendation system, a supervised learning, an unsupervised learning and a time series analysis. Using elimination process, following algorithm are discarded, the time series analysis algorithm because of no time series data available, the recommendation system algorithm because multiple products are not involved and the unsupervised learning algorithm because a specific prediction problem exists. Therefore a supervised learning method is selected to solve the target event. The selection of the algorithm is illustrated by circling the supervised learning algorithm in the table. A Naïve Bayes classification algorithm is used to illustrate the prediction of the target event. Other classification algorithms are also employed based on conditions. The target event is explained by attributes such as channel, age, education, occupation, previous outcome, etc.

FIG. 7G illustrates a training data set table to learn the predictive model for existing customers, according to an exemplary embodiment of the present disclosure. The system creates multiple training data sets and validation data sets with different ratio of data split. The data sets are then set to run with a plurality of selected algorithms. The system then recommends the best result from the result set obtained by the execution of the plurality of algorithms.

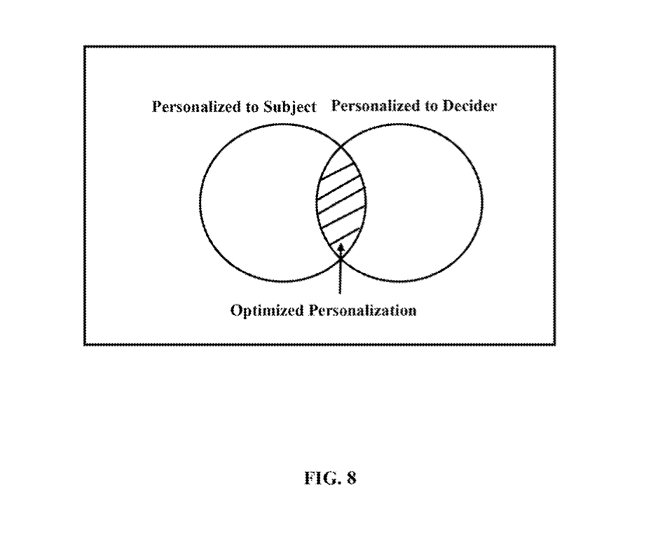

FIG. 8 illustrates a schematic representation of optimized personalization solution recommendation, according to an embodiment of the present disclosure. The embodiments herein are completely a self-learning relationship extraction and resolution process that needs very less or no human intervention. Also, the relationship hierarchy builder helps delivering more results to help accurate querying.

The embodiment of the present disclosure identifies and resolves relationships from structured and unstructured data and reconciles them together to build the relationship hierarchy. The embodiments of the present disclosure provide immense benefit in Retail, Health and Pharmaceutical services, Banking and Insurance and the like. Further the embodiments herein reduce project execution timelines and cost for a user who intends to use the medium to large data sets across different sectors.

According to an embodiment herein, the concept of semantic similarity is to find a relationship between two events to understand how the two events are related in terms of the effect on one on another. The concept of temporal distance between two attributes, as the term suggests, is to determine the impact one has on another, taking time into consideration.

According to an embodiment herein, a framework is provided for DS to rapidly formulate personalization problems. The framework prompts the DS/BA to think of non-obvious explanatory factors without being biased by obvious existing sources of data. A simple quantitative framework is provided to identify and automate the identification of most relevant predictive attributes from potentially hundreds of candidates. Further, there are no known instances of applying distances on unstructured data to identify the most relevant predictive factors. The framework is used in plurality of ways comprising using the framework as a methodology by analytics services providers or analytics professionals to solve predictive analytics problems and using the framework to create working modules of the various sub-frameworks and create an automated analysis workflow on a software platform to solve predictive analysis problems.

The foregoing description of the specific embodiments will so fully reveal the general nature of the embodiments herein that others can, by applying current knowledge, readily modify and/or adapt for various applications without departing from the generic concept, and, therefore, such adaptations and modifications should and are intended to be comprehended within the meaning and range of equivalents of the disclosed embodiments. It is to be understood that the terminology employed herein is for the purpose of description and not of limitation. Therefore, while the embodiments herein have been described in terms of preferred embodiments, those skilled in the art will recognize that the embodiments herein can be practiced with modification.

What is claimed is:

1. A method for providing a personalization solution based on a multi-dimensional data, the method comprises of:
identifying a target event for personalization;
profiling a plurality of entities associated with the target event;
identifying a plurality of attributes adapted for predicting the target event;
identifying one or more relevant attributes from the plurality of attributes;
determining a personalization context associated with the target event;
identifying at least one analysis algorithm for processing the identified target event; and
creating a predictive analytical model for building an optimal personalization solution.

2. The method of claim 1, wherein the target event is a personalization task which is formulated by analyzing an interaction between the plurality of entities, where the plurality of entities are explanatory factors for predicting an outcome of the target event.

3. The method of claim 1, wherein the plurality of entities comprises:
a decider adapted to perform a plurality of functions according to one or more recommendations provided by a personalization application; and
a subject on which a decision of the personalization application is applied;
wherein the subject and the decider comprises at least one of an entity, an employee or a consumer.

4. The method of claim 1, wherein the plurality of attributes comprises of an intrinsic attribute, a behavioral attribute and an environmental attribute.

5. The method of claim 1, wherein profiling the plurality of entities associated with the target event comprises of relating the one or more entities based on the plurality of attributes defined along three dimensions of the data, where the three dimensions of data comprises an intrinsic data, a behavioral data and an environmental data.

6. The method of claim 1, wherein identifying the plurality of attributes comprises of:
identifying a plurality of data sources for providing the attributes;
connecting an analysis platform to the plurality of identified data sources;
loading one or more attributes from the plurality of data sources to the analysis platform;
processing the one or more attributes;
recognizing one or more relevant attributes by computing a relevance metric based on a semantic distance and a temporal distance between at least one attribute and the target event, wherein the one or more attributes are predictive factors associated with the target event.

7. The method of claim 1, wherein the personalization context is determined by classifying the plurality of attributes into a preset number of segments, wherein each segment corresponds to a specific family of algorithms.

8. The method of claim 1, wherein identifying at least one analysis algorithm comprises of mapping the personalization context of the target event with a corresponding algorithm family.

9. A system combined with one or more processor implemented instructions for providing a personalization solution based on a multi-dimensional data, the system comprising:
an analyzing module adapted for identifying a target problem to be personalized;
a profiling module adapted for profiling a plurality of entities associated with the target event;
a personalization module adapted for:
identifying a plurality of attributes adapted for predicting the target event;
identifying one or more relevant attributes from the plurality of attributes;
determining a personalization context associated with the target event; and
identifying at least one analysis algorithm for processing the identified target event;
a predictive analytical module adapted for building an optimal personalization solution for the target event.

10. The system according to claim 9, wherein the plurality of entities comprises of:
a subject entity on which a prediction is to be made; and
a decider entity which selects a desired subject entity for predicting a personalization solution.

11. The system according to claim 9, wherein the target event comprises characteristics of the decider entity and the subject entity.
